(19) United States
(12) Patent Application Publication
(10) Pub. No.: US 2012/0112602 A1
(43) Pub. Date: May 10, 2012

(54) ULTRASONIC TRANSDUCER CELL AND ULTRASONIC TRANSDUCER CHANNEL AND ULTRASONIC TRANSDUCER INCLUDING THE ULTRASONIC TRANSDUCER CHANNEL

(75) Inventors: Kyung-il CHO, Seoul (KR); Dong-wook KIM, Seoul (KR)

(73) Assignee: SAMSUNG ELECTRONICS CO., LTD., Suwon-si (KR)

(21) Appl. No.: 13/159,745

(22) Filed: Jun. 14, 2011

(30) Foreign Application Priority Data
Nov. 4, 2010 (KR) 10-2010-0109258

(51) Int. Cl. H02N 1/00

(52) U.S. Cl. 310/300

(57) ABSTRACT

An ultrasonic transducer cell, an ultrasonic transducer channel, and an ultrasonic transducer including the ultrasonic transducer channel are provided. The ultrasonic transducer cell includes a substrate, at least three columns arranged on the substrate at regular intervals, and a thin film arranged on the at least three columns.

### CROSS-REFERENCE TO RELATED APPLICATIONS

This application claims the benefit under 35 U.S.C. §119(a) of a Korean Patent Application No. 10-2010-0109258, filed on Nov. 4, 2010, in the Korean Intellectual Property Office, the entire disclosure of which is incorporated herein by reference for all purposes.

### BACKGROUND

1. Field

The following description relates to an ultrasonic transducer cell and an ultrasonic transducer channel, and an ultrasonic transducer including the ultrasonic transducer channel.

2. Description of Related Art

A capacitive micro-machined ultrasonic transducer (cMUT) is a probe that transmits and receives ultrasonic waves by using a displacement difference between several hundreds to several thousands of diaphragms. The cMUT is manufactured by arranging a thin film having a thickness of several thousands of A on a silicon wafer used in a general semiconductor process, with a cavity of several thousands of A arranged there between. The silicon wafer and the thin film form a capacitor by having a vacuum cavity arranged there between. When alternating current (AC) flows in the capacitor, the thin film vibrates so that ultrasonic waves are generated there from. It is convenient to use the cMUT since the cMUT can transmit and receive ultrasonic waves without a contact medium of water, oil, or the like. Hereinafter, an ultrasonic transducer indicates a cMUT.

FIGS. 4A and 4B are plane views respectively illustrating related art examples of ultrasonic transducer channels 1, 5. Referring to FIG. 4A, the ultrasonic transducer channel 1 includes a plurality of ultrasonic transducer cells 4 for transmission, reception, or both transmission and reception, a substrate (not shown), a wall 3 arranged on the substrate, and a thin film 2 arranged on the wall 3. The ultrasonic transducer channel 1 includes sixteen ultrasonic transducer cells 4 in a rectangular dashed line.

Referring to FIG. 4B, an ultrasonic transducer channel 5 according to another comparative example may include a plurality of transmitting cells 6, a plurality of receiving cells 7, a wall 3, and a thin film 2, in which the transmitting cells 6 and the receiving cells 7 may be alternately arrayed. The ultrasonic transducer channel 5 includes eight transmitting cells 6 and eight receiving cells 7 in a rectangular dashed line.

In an ultrasonic transducer channel according to the related art, an ultrasonic transducer cell for transmission or reception is formed or defined by a wall and a circumference. That is, an edge portion of a thin film of the ultrasonic transducer cell is fixed. Thus, effective displacement of the thin film is not great. For example, vibration may occur only in a center portion of the thin film of the cell for transmission or reception. Further, in the ultrasonic transducer according to the related art, a cavity is separately arranged in every cell for transmission or reception.

### SUMMARY

In one general aspect, there is provided an ultrasonic transducer cell, including a substrate, at least three columns arranged on the substrate at regular intervals, and a thin film arranged on the at least three columns.

The general aspect of the ultrasonic transducer cell may further provide that the at least three columns are arrayed in a triangular form.

The general aspect of the ultrasonic transducer cell may further provide that each cross-section of the at least three columns is circular or polygonal.

The general aspect of the ultrasonic transducer cell may further provide a first electrode arranged on the substrate.

The general aspect of the ultrasonic transducer cell may further provide a second electrode arranged on the thin film to correspond to the first electrode.

In another general aspect, there is provided an ultrasonic transducer channel, including a substrate, a wall arranged on an edge portion of the substrate, a plurality of columns arranged on the substrate at regular intervals, a thin film arranged on the wall and the plurality of columns, and a cavity arranged between the substrate and the thin film.

The general aspect of the ultrasonic transducer channel may further provide that the plurality of columns is arrayed in a triangle mesh comprising a plurality of triangles.

The general aspect of the ultrasonic transducer channel may further provide that at least three adjacent columns from among the plurality of columns form an ultrasonic transducer cell.

The general aspect of the ultrasonic transducer channel may further provide that the ultrasonic transducer cell is disposed to partially overlap with an adjacent ultrasonic transducer cell, the ultrasonic transducer cell sharing a portion of the thin film with the adjacent ultrasonic transducer cell.

The general aspect of the ultrasonic transducer channel may further provide that a cross-section of each of the plurality of columns is circular or polygonal.

The general aspect of the ultrasonic transducer channel may further provide a first electrode arranged on the substrate.

The general aspect of the ultrasonic transducer channel may further provide a plurality of second electrodes arranged on the thin film.

The general aspect of the ultrasonic transducer channel may further provide a plurality of second electrodes arranged on the thin film and disposed on a center portion of the plurality of triangles.

The general aspect of the ultrasonic transducer channel may further provide a vibration-amplifying unit arranged on the thin film and disposed on a center portion of the plurality of triangles.

The general aspect of the ultrasonic transducer channel may further provide that the substrate comprises a bottom part and a plurality of protruding parts.

The general aspect of the ultrasonic transducer channel may further provide a plurality of first electrodes arranged on the bottom part.

The general aspect of the ultrasonic transducer channel may further provide a plurality of second electrodes arranged on the thin film to correspond to the plurality of first electrodes, respectively.

The general aspect of the ultrasonic transducer channel may further provide a plurality of third electrodes arranged on the plurality of protruding parts, respectively.

The general aspect of the ultrasonic transducer channel may further provide a plurality of fourth electrodes arranged on the thin film to correspond to the plurality of third electrodes, respectively.

In another general aspect, an ultrasonic transducer is provided, including a plurality of ultrasonic transducer channels. The plurality of ultrasonic transducer channels is arranged in an m×n array, where m and n are natural numbers equal to or greater than 1.

In another general aspect, an ultrasonic transducer channel is provided, including a substrate, a plurality of columns arranged on the substrate at regular intervals, a thin film supported by the plurality of columns, and a plurality of electrodes arranged on the thin film and disposed around each of the plurality of columns.

The general aspect of the ultrasonic transducer channel may further provide that the plurality of electrodes is disposed on respective vertexes of a virtual polygon with respect to each of the plurality of columns.

The general aspect of the ultrasonic transducer channel may further provide that the plurality of electrodes is disposed at regular intervals from each of the plurality of columns.

The general aspect of the ultrasonic transducer channel may further provide that the plurality of electrodes comprises six electrodes that are disposed on respective vertexes of a virtual hexagon with respect to the plurality of columns.

The general aspect of the ultrasonic transducer channel may further provide that the plurality of electrodes comprises three transmitting electrodes and three receiving electrodes that are alternately disposed on respective vertexes of a virtual hexagon with respect to the plurality of columns.

The general aspect of the ultrasonic transducer channel may further provide protruding parts on a region of the substrate, the protruding parts facing the three receiving electrodes, respectively.

Other features and aspects may be apparent from the following description, the drawings, and the claims.

### BRIEF DESCRIPTION OF THE DRAWINGS

FIG. 1 is a plane view illustrating an example of an ultrasonic transducer channel.

FIG. 2 is a cross-sectional view illustrating an example of an ultrasonic transducer channel along a line AA′ of FIG. 1.

FIG. 3 is another plane view illustrating an example of an ultrasonic transducer channel.

FIGS. 4A and 4B are plane views illustrating related art examples of ultrasonic transducer channels.

FIG. 5 is a plane view illustrating another example of an ultrasonic transducer channel.

FIG. 6 is a cross-sectional view illustrating another example of an ultrasonic transducer channel along a line BB′ of FIG. 5.

FIG. 7 is another plane view illustrating another example of an ultrasonic transducer channel.

FIG. 8 is a plane view illustrating yet another example of an ultrasonic transducer channel.

FIG. 9A is a cross-sectional view illustrating an example of an ultrasonic transducer.

FIG. 9B is a plane view illustrating an example of the ultrasonic transducer shown from an arrow of FIG. 9A.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses, and/or methods described herein will be suggested to those of ordinary skill in the art. In addition, description of well-known functions and constructions may be omitted for increased clarity and conciseness.

It is understood that the features of the present disclosure may be embodied in different forms and should not be constructed as limited to the example embodiment(s) set forth herein. Rather, embodiment(s) are provided so that this disclosure will be thorough and complete, and will convey the full scope of the present disclosure to those skilled in the art. The drawings may not be necessarily to scale, and, in some instances, proportions may have been exaggerated in order to clearly illustrate features of the embodiment(s). When a first layer is referred to as being “on” a second layer or “on” a substrate, it may not only refer to a case where the first layer is formed directly on the second layer or the substrate but may also refer to a case where a third layer exists between the first layer and the second layer or the substrate.

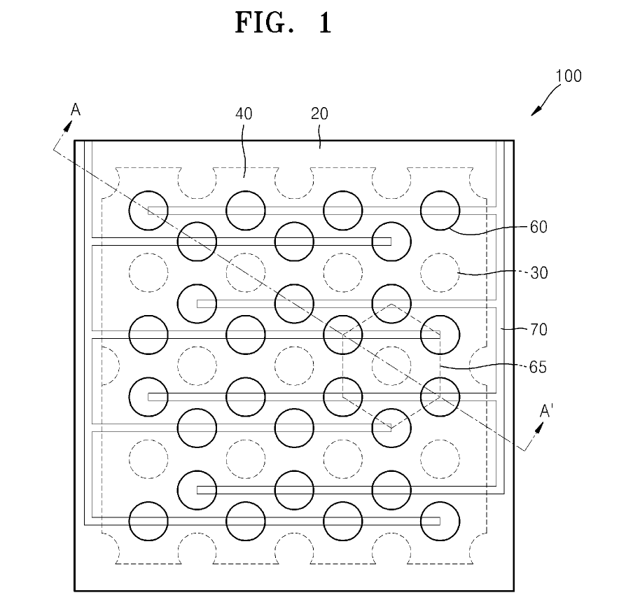

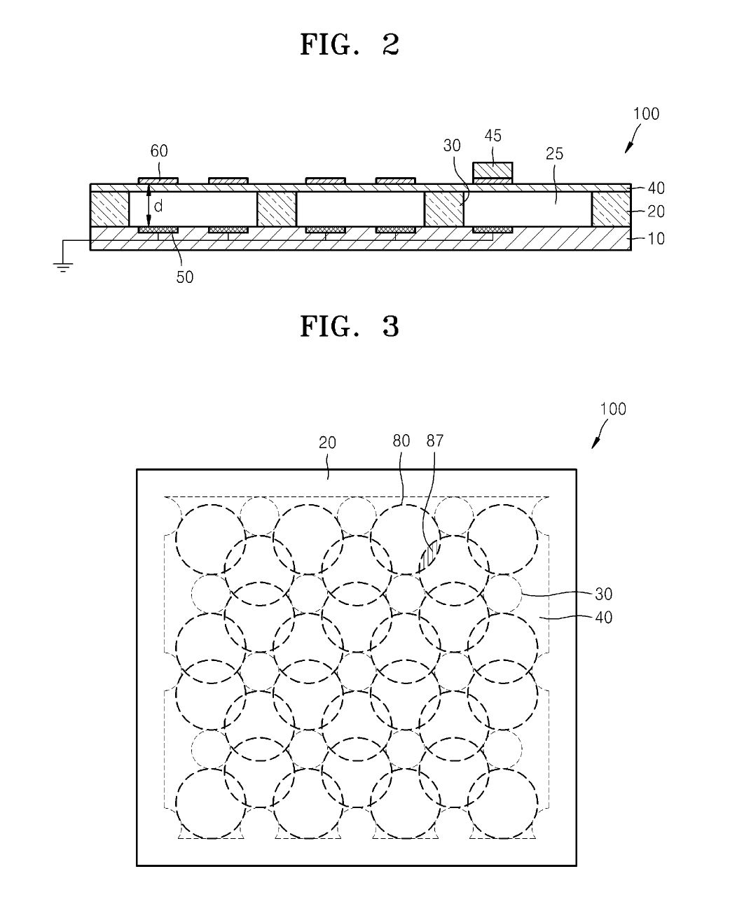

FIG. 1 is a plane view illustrating an example of an ultrasonic transducer channel 100. FIG. 2 is a cross-sectional view illustrating an example of the ultrasonic transducer channel 100 along a line AA′ of FIG. 1.

Referring to FIGS. 1 and 2, the ultrasonic transducer channel 100 includes a substrate 10, a wall 20 arranged on an edge of the substrate 10, a plurality of columns 30 arranged on the substrate 10 at regular intervals, a thin film 40 arranged on the wall 20 and the columns 30, and a cavity 25 arranged between the substrate 10 and the thin film 40.

In addition, the ultrasonic transducer channel 100 of FIG. 1 may be an element or a channel included in an ultrasonic transducer (not shown). The ultrasonic transducer channel 100 may include a plurality of ultrasonic transducer cells (not shown). The ultrasonic transducer may include a plurality of ultrasonic transducer channels 100, and the plurality of ultrasonic transducer channels 100 may be arranged in an m×n array, where m and n are natural numbers equal to or greater than 1.

The substrate 10 may include silicon. The wall 20 and the columns 30 are formed on the substrate 10, and may be integrally formed with the substrate 10. That is, the wall 20 and the columns 30 may be formed on the substrate 10 by etching the substrate 10.

The wall 20 is arranged on an edge portion of the substrate 10, and may be formed of the same material as the substrate 10. In a case where the ultrasonic transducer channels 100 are arranged in an array, the wall 20 may be shared between adjacent ultrasonic transducer channels 100. Although the wall 20 is distinctive from the substrate 10 in FIG. 2, the wall 20 may be integrally formed with the substrate 10. The wall 20 surrounds the columns 30 arranged on the substrate 10, and may contact some of the columns 30 that are arranged near the edge portion of the substrate 10.

The columns 30 may be arranged on the substrate 10 at regular intervals. That is, the columns 30 may have island forms that are separate from each other. Although the columns 30 are distinctive from the substrate 10 in FIG. 2, the columns 30 may be integrally formed with the substrate 10.

In addition, the columns 30 may be arrayed in a triangle mesh including a plurality of triangles. For example, three adjacent columns 30 from among the columns 30 may be arrayed in a regular triangle. A cross-section of each column 30 may be circular but is not limited thereto, and thus, may have a polygonal shape, including a triangular shape, a rectangular shape, or the like.

The thin film 40 is arranged on the wall 20 and the columns 30. Portions of the thin film 40, which are not supported by the wall 20 and the columns 30, may vibrate for transmission or reception of ultrasonic waves. An example of the ultrasonic transducer channel 100 provides that an ultrasonic transducer cell for transmission or reception is not formed by a wall, but is formed or defined by at least three columns 30, so that a portion of the thin film 40 fixed by the wall 20 or the columns 30 is small. Thus, an effective displacement of the thin film 40 may be greater than an effective displacement of the thin film according to the related art.

That is, a region of the thin film 40 of an ultrasonic transducer cell for transmission or reception in which vibration occurs may be greater than a region of a thin film of an ultrasonic transducer cell for transmission or reception in the related art in which vibration occurs. A thickness of the thin film 40 may be adjusted according to whether the ultrasonic transducer channel 100, or an ultrasonic transducer cell which is included in the ultrasonic transducer channel 100 is for transmission, reception, or both transmission and reception.

In addition, the cavity 25 is arranged between the substrate 10 and the thin film 40. The cavity 25 may be formed by the substrate 10, the thin film 40, and the wall 20, and may be vacuous. An example of the ultrasonic transducer channel 100 provides that a plurality of ultrasonic transducer cells for transmission, reception, or both transmission and reception may share the cavity 25.

That is, in the ultrasonic transducer channel 100, the ultrasonic transducer cells are not spatially divided by a wall but are formed by the columns 30, so that the cavity 25 of the ultrasonic transducer cells is not divided but may be arranged as one space. A thickness of the cavity 25 may be adjusted according to whether the ultrasonic transducer channel 100 is for transmission, reception, or both transmission and reception.

A plurality of first electrodes 50 are arranged on the substrate 10. In more detail, the first electrodes 50 may be arranged on the substrate 10 without contacting the columns 30. For example, in a case where the columns 30 are arrayed in the triangle mesh, the first electrodes 50 may be arranged in a region corresponding to a center portion of each triangle of the triangle mesh. The first electrodes 50 may be commonly grounded. Each of the first electrodes 50 may have a polygonal shape, such as a circular shape, a triangular shape, a rectangular shape, or the like. The first electrodes 50 may be arranged as one layer on the substrate 10.

A plurality of second electrodes 60 may be arranged on or below the thin film 40. In addition, the second electrodes 60 may be arranged to correspond to the first electrodes 50 arranged on the substrate 10. That is, the second electrodes 60 may be arranged in parallel with the first electrodes 50. Moreover, each of the second electrodes 60 may have a polygonal shape, such as a circular shape, a triangular shape, a rectangular shape, or the like.

In an example of an ultrasonic transducer cell for transmission, direct current (DC) is applied between the first electrodes 50 and the second electrodes 60. Then, alternating current (AC) is additionally applied there between, so that the thin film 40 vibrates, and thus, ultrasonic waves may be transmitted.

In an example of an ultrasonic transducer cell for reception, only DC is applied between the first electrodes 50 and the second electrodes 60. Then, external ultrasonic waves vibrate the thin film 40, so that AC may be generated from the vibration.

In an example of an ultrasonic transducer cell for transmission and reception, for transmission, DC is applied between the first electrodes 50 and the second electrodes 60, and AC is additionally applied there between, so that the thin film 40 vibrates, and thus, ultrasonic waves may be transmitted. For reception, only DC is applied between the first electrodes 50 and the second electrodes 60. Then external ultrasonic waves vibrate the thin film 40, so that an electrical signal such as AC may be generated from the vibration.

The second electrodes 60 may be arranged on a top surface or a bottom surface of the thin film 40, and may be disposed around each of the columns 30 or be centered on each of the columns 30. That is, the respective second electrodes 60 may be disposed on respective vertexes of a virtual polygon with respect to each of the columns 30 to be centered on each of the columns 30. The virtual polygon indicates a virtual planar figure created by connecting center points of the second electrodes 60.

For example, six respective second electrodes 60 may be disposed on respective vertexes of a virtual hexagon 65 with respect to the column 30. The second electrodes 60 may be disposed at regular intervals from the column 30. Here, the first and second electrodes 50 and 60 may indicate electrodes for transmission, reception, or both transmission and reception.

A distance d between the first electrode 50 and the second electrode 60, of which an example is illustrated in FIG. 2, may be adjusted according to whether the ultrasonic transducer channel 100 or an ultrasonic transducer cell which is included in the ultrasonic transducer channel 100 is for transmission, reception, or both transmission and reception.

For example, for transmission, the distance d between the first electrode 50 and the second electrode 60 may be in a range of about 0.15 μm to about 0.2 μm, and, for reception, the distance d may be in a range of about 0.3 μm to about 0.5 μm. For both transmission and reception, the distance d between the first electrode 50 and the second electrode 60 may be in a range of about 0.15 μm to about 0.5 μm. In addition, as illustrated in FIG. 1, the second electrodes 60 may be electrically connected by an electric line 70 arranged on the thin film 40.

A vibration-amplifying unit 45 may be further arranged on the thin film 40. Referring to the example illustrated in FIG. 2, the vibration-amplifying unit 45 is arranged on the second electrode 60.

However, arrangement of the vibration-amplifying unit 45 is not limited thereto. Thus, the vibration-amplifying unit 45 may be formed to cover the second electrode 60. The vibration-amplifying unit 45 may amplify vibration of the thin film 40 by allowing the thin film 40 to vertically vibrate like a piston without bending like a bow. By doing so, an output of ultrasonic wave transmission of the ultrasonic transducer channel 100 may be amplified.

FIG. 3 is a plane view illustrating an example of the ultrasonic transducer channel 100, in which a plurality of ultrasonic transducer cells 80 that are included in the ultrasonic transducer channel 100 are shown.

Referring to FIG. 3, the ultrasonic transducer channel 100 may include the plurality of ultrasonic transducer cells 80. Each ultrasonic transducer cell 80 may be formed or defined by at least three adjacent columns 30 from among the columns 30. Each ultrasonic transducer cell 80 may include the substrate 10, the first electrode 50 on the substrate 10, the columns 30, the thin film 40 on the columns 30, and the second electrode 60 arranged on the top surface or the bottom surface of the thin film 40.

The ultrasonic transducer cell 80 may partially overlap with adjacent ultrasonic transducer cells 80, as to share a portion of the thin film 40. That is, the ultrasonic transducer cells 80 may mutually have an ultrasonic transducer cell share area 87 with adjacent ultrasonic transducer cells 80. Thus, the ultrasonic transducer cells 80 do not separately have cavities but may share the cavity 25 that is one space. The ultrasonic transducer cell 80 of the ultrasonic transducer channel 100 may be an ultrasonic transducer cell for transmission, an ultrasonic transducer cell for reception, or an ultrasonic transducer cell for both transmission and reception.

In the ultrasonic transducer channel 100, the ultrasonic transducer cell for transmission or reception has a structure in which the thin film 40 is not supported by a wall but is supported by at least three columns 30, so that effective displacement of the thin film 40 may be greater than effective displacement of a thin film of an ultrasonic transducer cell of the related art.

That is, compared to the vibration that occurs in a region of a thin film of an ultrasonic transducer cell of the related art, a region of the thin film 40 of the ultrasonic transducer cell 80 in which vibration occurs may be increased. As a result, a transmission output of the ultrasonic transducer channel 100 may be amplified or a receiving sensitivity may be improved.

Although the ultrasonic transducer cell 80 in the example illustrated in FIG. 3 has a circular shape for convenience of description and distinction, a shape of the ultrasonic transducer cell 80 is not limited to the circular shape. In addition, the ultrasonic transducer cells 80 may not be spatially divided but may be functionally classified. That is, a region for transmitting or receiving ultrasonic waves may be defined as the ultrasonic transducer cell 80.

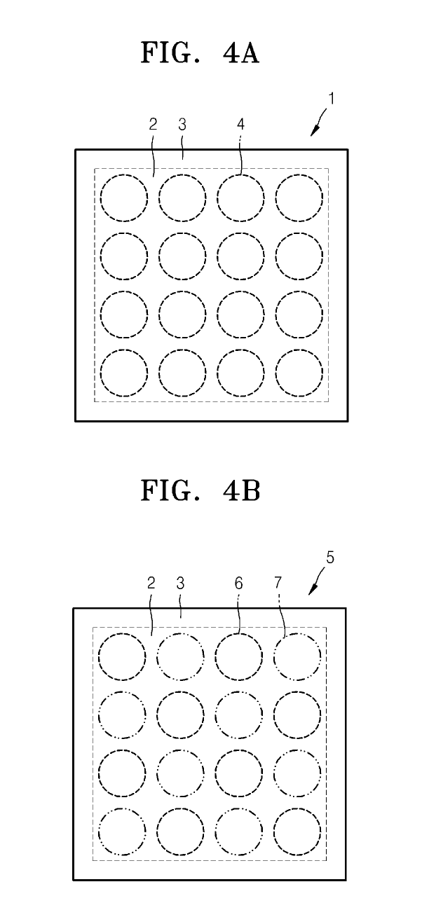

Referring to the related art example illustrated in FIG. 4A, the dashed line indicates the equivalency of the wall 20 of the ultrasonic transducer channel 100. An area within the dashed line is equivalent to an area of the ultrasonic transducer channel 100 excluding the wall 20. The ultrasonic transducer channel 100 may include twenty-eight ultrasonic transducer cells 80. That is, the ultrasonic transducer channel 100 may include more ultrasonic transducer cells 80 for transmission, reception, or both transmission and reception for each unit area compared with the ultrasonic transducer channel 1.

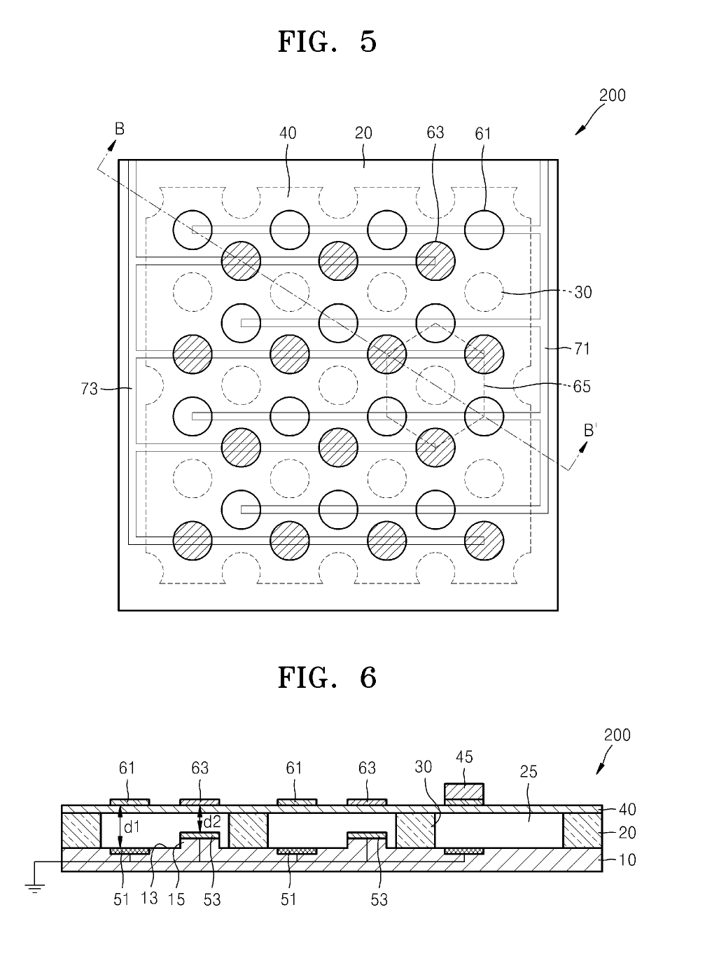

FIG. 5 is a plane view illustrating an example of an ultrasonic transducer channel 200. FIG. 6 is a cross-sectional view illustrating an example of the ultrasonic transducer channel 200 along a line BB′ of FIG. 5.

Referring to FIGS. 5 and 6, the ultrasonic transducer channel 200 includes a substrate 10 including a bottom part 13 and a plurality of protruding parts 15, a wall 20 arranged on an edge portion of the substrate 10, a plurality of columns 30 arranged on the substrate 10 at regular intervals, a thin film 40 arranged on the wall 20 and the columns 30, and a cavity 25 arranged between the substrate 10 and the thin film 40.

In addition, the ultrasonic transducer channel 200 may be an element or a channel included in an ultrasonic transducer (not shown). The ultrasonic transducer may include a plurality of ultrasonic transducer channels 200, and the plurality of ultrasonic transducer channels 200 may be arranged in an m×n array, where m and n are natural numbers equal to or greater than 1.

The substrate 10 may include silicon. The wall 20 and the columns 30 are formed on the substrate 10, and may be integrally formed with the substrate 10. That is, the wall 20 and the columns 30 may be formed on the substrate 10 by etching the substrate 10.

Further, the substrate 10 includes the bottom part 13 and the plurality of protruding parts 15. Each protruding part 15 has a column shape projected from the bottom part 13. That is, each protruding part 15 is projected to have a greater height than that of the bottom part 13. A top surface of each protruding part 15 may be flat. A cross-section of each protruding part 15 may be a circular shape or a polygonal shape. The bottom part 13 and the protruding parts 15 may be formed by differentiating levels of the etching performed on the substrate 10.

The wall 20 is arranged on the edge portion or near the edge portion of the substrate 10, and may be formed of the same material as the substrate 10. In a case where the ultrasonic transducer channels 200 are arranged in an array, the wall 20 may be shared between adjacent ultrasonic transducer channels 200. Although the wall 20 is distinctive from the substrate 10 in FIG. 6, the wall 20 may be integrally formed with the substrate 10. The wall surrounds the columns 30 arranged on the substrate 10, and may be adjacent to some of the columns 30 that are arranged near the edge portion of the substrate 10.

The columns 30 may be arranged on the substrate 10 at regular intervals. That is, the columns 30 may have island forms that are separate from each other. Although the columns 30 are distinctive from the substrate 10 in FIG. 6, the columns 30 may be integrally formed with the substrate 10.

In addition, the columns 30 may be arrayed in a triangle mesh including a plurality of triangles. For example, three adjacent columns 30 from among the columns 30 may be arrayed in a regular triangle. A cross-section of each column 30 may be circular but is not limited thereto, and, thus, may have a polygonal shape, including a triangular shape, a rectangular shape, or the like.

The thin film 40 is arranged on the wall 20 and the columns 30. Portions of the thin film 40, which are not supported by the wall 20 and the columns 30, may vibrate for transmission or reception of ultrasonic waves. An example of the ultrasonic transducer channel 200 provides that an ultrasonic transducer cell for transmission or reception is not formed by a wall, but is formed by at least three columns 30, so that a portion of the thin film 40 fixed by the wall 20 or the columns 30 is small. Thus, an effective displacement of the thin film 40 may be greater than an effective displacement of the thin film according to the related art.

That is, a region of the thin film 40 of an ultrasonic transducer cell for transmission or reception in which vibration occurs may be greater than a region of a thin film of an ultrasonic transducer cell for transmission or reception in the related art in which vibration occurs. A thickness of the thin film 40 may be adjusted in consideration of ultrasonic wave transmission and reception of the ultrasonic transducer channel 200.

In addition, the cavity 25 is arranged between the substrate 10 and the thin film 40. The cavity 25 may be formed by the substrate 10, the thin film 40, and the wall 20, and may be vacuous. An example of the ultrasonic transducer channel 200 provides that a plurality of ultrasonic transducer cells for transmission and reception may share the cavity 25.

That is, in the ultrasonic transducer channel 200, the ultrasonic transducer cells are not spatially divided by a wall but are formed by the columns 30, so that the cavity 25 of the ultrasonic transducer cells is not divided but may be arranged as one space. A thickness of the cavity 25 may be selected in consideration of ultrasonic wave transmission and reception of the ultrasonic transducer channel 200.

A plurality of first electrodes 51 may be arranged on the substrate 10. In more detail, a plurality of the first electrodes 51 may be arranged on the bottom part 13 of the substrate 10. In addition, a plurality of third electrodes 53 may be arranged on the substrate 10. In more detail, a plurality of the third electrodes 53 may be arranged on the protruding parts 15 of the substrate 10, respectively. The first electrodes 51 and the third electrodes 53 may be alternately arrayed.

For example, in a case where the columns 30 are arrayed in the triangle mesh, the first electrodes 51 and the third electrodes 53 may be arranged in a region corresponding to a center portion of each triangle of the triangle mesh. The first electrodes 51 and the third electrodes 53 may be commonly grounded. Each first electrode 51 and each third electrode 53 may have a polygonal shape, such as a circular shape, a triangular shape, a rectangular shape, or the like.

A plurality of second electrodes 61 and a plurality of fourth electrodes 63 may be arranged on or below the thin film 40. In addition, the second electrodes 61 may be arranged to correspond to the first electrodes 51 arranged on the bottom part 13. That is, the second electrodes 61 may be arranged in parallel with the first electrodes 51. Moreover, the fourth electrodes 63 may be arranged to correspond to the third electrodes 53 arranged on the protruding parts 15, respectively. That is, the fourth electrodes 63 may be arranged in parallel with the third electrodes 53.

The second electrodes 61 and the fourth electrodes 63 may be arranged on a top surface or a bottom surface of the thin film 40, and may be disposed around each of the columns 30. That is, the respective second electrodes 61 and the respective fourth electrodes 63 may be alternately disposed on respective vertexes of a virtual polygon with respect to each of the columns 30 to be centered about each of the columns 30. The virtual polygon indicates a virtual planar figure created by connecting center points of the second electrodes 61 and the fourth electrodes 63.

For example, three respective second electrodes 61 and three respective fourth electrodes 63 may be disposed on respective vertexes of a virtual hexagon 65 with respect to the column 30. The second electrodes 61 and the fourth electrodes 63 may be disposed at regular intervals from the column 30. Here, the first and second electrodes 51 and 61 may indicate electrodes for transmission, and the third and fourth electrodes 53 and 63 may indicate electrodes for reception.

In an example of the ultrasonic transducer cell including the first and second electrodes 51 and 61 for transmission, DC is applied between the first electrodes 51 and the second electrodes 61. Then, AC is additionally applied there between, so that the thin film 40 vibrates, and thus, ultrasonic waves may be transmitted. A distance d₁ between each first electrode 51 and each second electrode 61 may be selected to maximize an ultrasonic wave transmission output. For example, the distance d₁ may be in a range of about 0.3 μm to about 0.5 μm.

In the ultrasonic transducer cell including the third and fourth electrodes 53 and 63 for reception, only DC is applied between the third electrodes 53 and the fourth electrodes 63. Then, external ultrasonic waves vibrate the thin film 40, so that an electrical signal such as AC may be generated from the vibration. A distance d₂ between each third electrode 53 and each fourth electrode 63 may be selected to increase sensitivity with respect to ultrasonic wave reception. For example, the distance d₂ may be in a range of about 0.15 μm to about 0.2 μm.

In addition, as illustrated in FIG. 5, the second electrodes 61 may be electrically connected by an electric line 71 arranged on the thin film 40, and the fourth electrodes 63 may be electrically connected by an electric line 73 arranged on the thin film 40. The electric line 71 and the electric line 73 may be arranged such that that the electric line 71 and the electric line 73 do not meet each other.

A vibration-amplifying unit 45 may be further arranged on the thin film 40. Referring to example illustrated in FIG. 6, the vibration-amplifying unit 45 is arranged on the second electrode 61. However, arrangement of the vibration-amplifying unit 45 is not limited thereto. Thus, the vibration-amplifying unit 45 may be formed to cover the second electrode 61. The vibration-amplifying unit 45 may amplify vibration of the thin film 40 by allowing the thin film 40 to vertically vibrate like a piston without bending like a bow. By doing so, an output of ultrasonic wave transmission of the ultrasonic transducer channel 200 may be amplified.

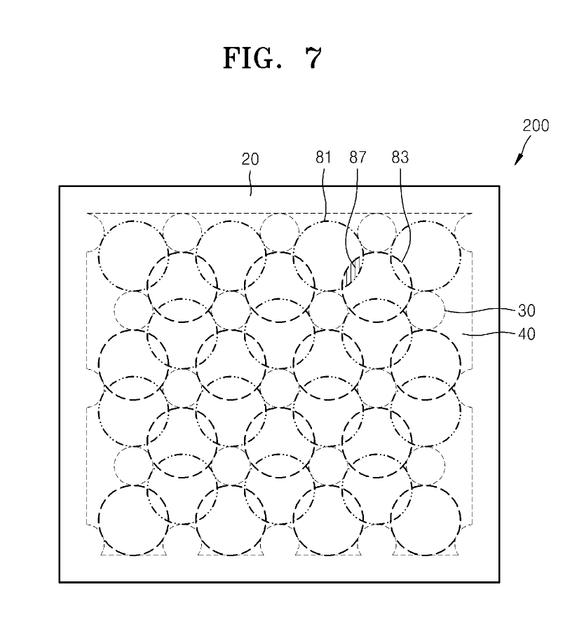

FIG. 7 is a plane view illustrating an example of an ultrasonic transducer channel 200, in which a plurality of transmitting ultrasonic transducer cells 81 and a plurality of receiving ultrasonic transducer cells 83, which are included in the ultrasonic transducer channel 200, are shown.

Referring to FIG. 7, the ultrasonic transducer channel 200 may include the transmitting ultrasonic transducer cells 81 and the plurality of receiving ultrasonic transducer cells 83. Each transmitting ultrasonic transducer cell 81 and each receiving ultrasonic transducer cell 83 may be formed by at least three adjacent columns 30 from among the columns 30.

In addition, referring to FIG. 6, each transmitting ultrasonic transducer cell 81 may include the substrate 10, the first electrode 51 on the bottom part 13, the columns 30, the thin film 40 on the columns 30, and the second electrode 61 arranged on the top surface or the bottom surface of the thin film 40. Each receiving ultrasonic transducer cell 83 may include the substrate 10, the third electrode 53 on the protruding part 15, the columns 30, the thin film 40 on the columns 30, and the fourth electrode 63 arranged on the top surface or the bottom surface of the thin film 40.

The transmitting ultrasonic transducer cell 81 and the receiving ultrasonic transducer cell 83 may partially overlap each other, so that they may share a portion of the thin film 40. That is, the transmitting ultrasonic transducer cell 81 and the receiving ultrasonic transducer cell 83 may mutually have an ultrasonic transducer cell share area 87 with adjacent ultrasonic transducer cells 80.

Thus, the transmitting ultrasonic transducer cell 81 and the receiving ultrasonic transducer cell 83 do not separately have cavities but may share the cavity 25 that is one space. In the ultrasonic transducer channel 200, the transmitting ultrasonic transducer cell 81 and the receiving ultrasonic transducer cell 83 have a structure in which the thin film 40 is not supported by a wall but is supported by at least three columns 30, so that effective displacement of the thin film 40 may be greater than effective displacement of a thin film of an ultrasonic transducer cell of the related art.

That is, compared to the vibration that occurs in a region of a thin film of an ultrasonic transducer cell of the related art, a region of the thin film 40 of each of the transmitting ultrasonic transducer cell 81 and the receiving ultrasonic transducer cell 83 in which vibration occurs may be increased. As a result, a transmission output of the ultrasonic transducer channel 200 may be amplified and a receiving sensitivity may be improved.

Although the transmitting ultrasonic transducer cell 81 and the receiving ultrasonic transducer cell 83 in the example illustrated in FIG. 7 have a circular shape for convenience of description and distinction, a shape of the transmitting ultrasonic transducer cell 81 and the receiving ultrasonic transducer cell 83 is not limited to the circular shape.

Referring to the related art example illustrated in FIG. 4B, a dashed line indicates the wall 12 of the ultrasonic transducer channel 200, and an area within the dashed line is equivalent to an area of the ultrasonic transducer channel 200 excluding the wall 20. The ultrasonic transducer channel 200 of FIG. 7 may include fourteen transmitting ultrasonic transducer cells 81 and fourteen receiving ultrasonic transducer cells 83.

That is, the ultrasonic transducer channel 200 may include more transmitting ultrasonic transducer cells 81 and the receiving ultrasonic transducer cells 83 for each unit area compared with the ultrasonic transducer channel 5. Thus, the ultrasonic wave transmission output of the ultrasonic transducer channel 200 may be amplified and its receiving sensitivity may be improved.

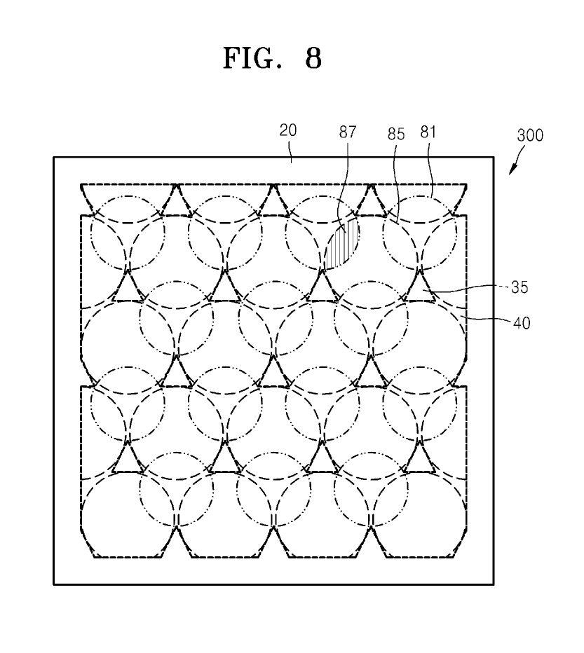

FIG. 8 is a plane view illustrating an example of an ultrasonic transducer channel 300. Hereinafter, the ultrasonic transducer channel 300 will be described in consideration of differences between the ultrasonic transducer channel 300 and the ultrasonic transducer channels 100 and 200 described above.

Referring to FIG. 8, the ultrasonic transducer channel 300 may include a plurality of transmitting ultrasonic transducer cells 81 and a plurality of receiving ultrasonic transducer cells 85. Each transmitting ultrasonic transducer cell 81 and each receiving ultrasonic transducer cell 85 may be formed by at least three adjacent columns 35 from among columns 35.

The transmitting ultrasonic transducer cell 81 and the receiving ultrasonic transducer cell 85 may partially overlap each other, so that they may share a portion of a thin film 40. That is, the transmitting ultrasonic transducer cell 81 and the receiving ultrasonic transducer cell 85 may mutually have an ultrasonic transducer cell share area 87 with the adjacent transmitting ultrasonic transducer cells 81 and receiving ultrasonic transducer cells 85.

Unlike the ultrasonic transducer channels 100 and 200 described above, a cross-section of each column 35 of the ultrasonic transducer channel 300 may have a triangular shape. In this case, a size of the transmitting ultrasonic transducer cell 81 formed by vertexes of the triangular-shape columns 35 may be equivalent to a size of the transmitting ultrasonic transducer cell 81 of the ultrasonic transducer channel 200 in FIG. 7. However, a size of the receiving ultrasonic transducer cell 85 formed by sides of the triangular-shape columns 35 may be greater than a size of the receiving ultrasonic transducer cell 83 of the ultrasonic transducer channel 200 in FIG. 7.

Conversely, the transmitting ultrasonic transducer cell 81 of the ultrasonic transducer channel 300 may be formed by the sides of the triangular-shaped columns 35, so that the size of the transmitting ultrasonic transducer cell 81 may be increased. In this manner, the size of the transmitting ultrasonic transducer cell 81 or the size of the receiving ultrasonic transducer cell 85 may be selected by varying a shape of the columns 35, so that a transmission output of the ultrasonic transducer channel 300 may be amplified or its receiving sensitivity may be improved. While the shape of each column 35 is triangular in FIG. 8, the shape is not limited thereto, and thus, may be one of various polygonal shapes.

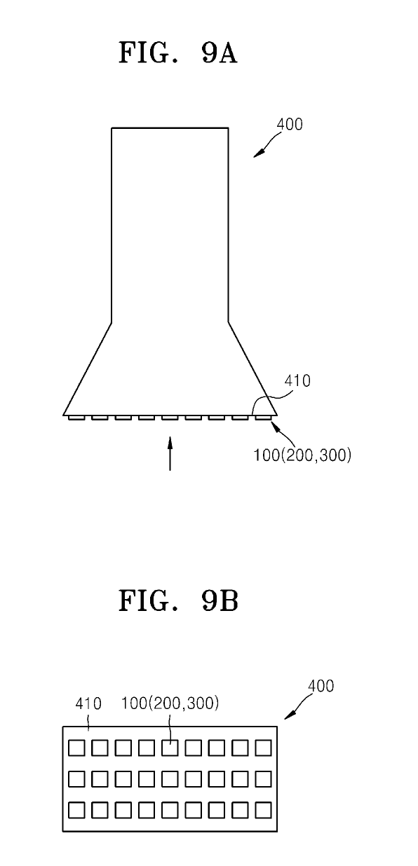

FIG. 9A is a cross-sectional view illustrating an example of an ultrasonic transducer 400, and FIG. 9B is a plane view illustrating an example of the ultrasonic transducer 400 shown from an arrow of FIG. 9A.

Referring to FIG. 9A and FIG. 9B, the ultrasonic transducer 400 may include a plurality of ultrasonic transducer channels 100. The plurality of ultrasonic transducer channels 100 may be disposed on a surface of the ultrasonic transducer 400, for example, a bottom surface 410. The plurality of ultrasonic transducer channels 100 may be arranged in an m×n array, where m an n are natural numbers equal to or greater than 1. Meanwhile, the ultrasonic transducer 400 may include a plurality of ultrasonic transducer channels 200 or 300.

A number of examples have been described above. Nevertheless, it will be understood that various modifications may be made. For example, suitable result may be achieved if the described techniques are performed in a different order and/or components described herein are combined in a different manner and/or replaced or supplement by other components or their equivalents. Accordingly, other implementations are within the scope of the following claims.

What is claimed is:

1. An ultrasonic transducer cell, comprising:
a substrate;
at least three columns arranged on the substrate at regular intervals; and
a thin film arranged on the at least three columns.

2. The ultrasonic transducer cell of claim 1, wherein the at least three columns are arrayed in a triangular form.

3. The ultrasonic transducer cell of claim 1, wherein each cross-section of the at least three columns is circular or polygonal.

4. The ultrasonic transducer cell of claim 1, further comprising:
a first electrode arranged on the substrate.

5. The ultrasonic transducer cell of claim 4, further comprising:
a second electrode arranged on the thin film to correspond to the first electrode.

6. An ultrasonic transducer channel, comprising:
a substrate;
a wall arranged on an edge portion of the substrate;
a plurality of columns arranged on the substrate at regular intervals;
a thin film arranged on the wall and the plurality of columns; and
a cavity arranged between the substrate and the thin film.

7. The ultrasonic transducer channel of claim 6, wherein the plurality of columns is arrayed in a triangle mesh comprising a plurality of triangles.

8. The ultrasonic transducer channel of claim 7, wherein at least three adjacent columns from among the plurality of columns form an ultrasonic transducer cell.

9. The ultrasonic transducer channel of claim 8, wherein the ultrasonic transducer cell is disposed to partially overlap with an adjacent ultrasonic transducer cell, the ultrasonic transducer cell sharing a portion of the thin film with the adjacent ultrasonic transducer cell.

10. The ultrasonic transducer channel of claim 6, wherein a cross-section of each of the plurality of columns is circular or polygonal.

11. The ultrasonic transducer channel of claim 6, further comprising:
a first electrode arranged on the substrate.

12. The ultrasonic transducer channel of claim 6, further comprising:
a plurality of second electrodes arranged on the thin film.

13. The ultrasonic transducer channel of claim 7, further comprising:
a plurality of second electrodes arranged on the thin film and disposed on a center portion of the plurality of triangles.

14. The ultrasonic transducer channel of claim 7, further comprising:
a vibration-amplifying unit arranged on the thin film and disposed on a center portion of the plurality of triangles.

15. The ultrasonic transducer channel of claim 6, wherein the substrate comprises a bottom part and a plurality of protruding parts.

16. The ultrasonic transducer channel of claim 15, further comprising:
a plurality of first electrodes arranged on the bottom part.

17. The ultrasonic transducer channel of claim 16, further comprising:
a plurality of second electrodes arranged on the thin film to correspond to the plurality of first electrodes, respectively.

18. The ultrasonic transducer channel of claim 15, further comprising:
a plurality of third electrodes arranged on the plurality of protruding parts, respectively.

19. The ultrasonic transducer channel of claim 18, further comprising:
a plurality of fourth electrodes arranged on the thin film to correspond to the plurality of third electrodes, respectively.

20. An ultrasonic transducer, comprising:
a plurality of ultrasonic transducer channels of claim 6,
wherein the plurality of ultrasonic transducer channels is arranged in an m×n array, where m and n are natural numbers equal to or greater than 1.

21. An ultrasonic transducer channel, comprising:
a substrate;
a plurality of columns arranged on the substrate at regular intervals;
a thin film supported by the plurality of columns; and
a plurality of electrodes arranged on the thin film and disposed around each of the plurality of columns.

22. The ultrasonic transducer channel of claim 21, wherein the plurality of electrodes is disposed on respective vertexes of a virtual polygon with respect to each of the plurality of columns.

23. The ultrasonic transducer channel of claim 21, wherein the plurality of electrodes is disposed at regular intervals from each of the plurality of columns.

24. The ultrasonic transducer channel of claim 21, wherein the plurality of electrodes comprises six electrodes that are disposed on respective vertexes of a virtual hexagon with respect to the plurality of columns.

25. The ultrasonic transducer channel of claim 21, wherein the plurality of electrodes comprises three transmitting electrodes and three receiving electrodes that are alternately disposed on respective vertexes of a virtual hexagon with respect to the plurality of columns.

26. The ultrasonic transducer channel of claim 25, further comprising:
protruding parts on a region of the substrate, the protruding parts facing the three receiving electrodes, respectively.
